(19) United States
(12) Patent Application Publication
(10) Pub. No.: US 2026/0063791 A1
(43) Pub. Date: Mar. 5, 2026

(54) METHOD, PROCESSOR, AND SYSTEM FOR FUSION DETECTION

(71) Applicant: AutoSys (TW) Co., Ltd., Hsinchu County (TW)

(72) Inventors: Peter Chondro, SURABAYA (ID); Bo-Yu Chen, Hsinchu County (TW); Tse-Min Chen, Hsinchu County (TW)

(21) Appl. No.: 18/817,968

(22) Filed: Aug. 28, 2024

(51) Int. Cl. G01S 13/86; G01S 13/931; G06F 16/25

(52) U.S. Cl. CPC G01S 13/867; G01S 13/931; G06F 16/258

(57) ABSTRACT

A fusion detection method, comprising: establishing a table corresponding to multiple blocks of a frame, where N is a natural number; determining a value of each cell of the table according to a historical first value of objection detections of corresponding blocks across from a 0-th first sensing data to a N-th first sensing data and a historical second value of objection detections of the corresponding blocks across from a 0-th second sensing data to a N-th second sensing data; and determining whether an object detection of the frame is presented or not based on the value of the cell corresponding to the block of the object detection, wherein the 0-th first sensing data to the N-th first sensing data are gathered from a first sensor, the 0-th second sensing data to the N-th second sensing data are gathered from a second sensor.

### CROSS REFERENCE TO RELATED PATENT APPLICATION

### Field of the Invention

The present invention relates to sensor fusion, and more particularly, to decision of object detection in the sensor fusion.

### BACKGROUND OF THE INVENTION

Autonomous or assistive vehicles are getting popular in the modern world. Navigating in a complicated environment requires situational awareness. The situational awareness comes from recognition and perception of sensing data gathered by the sensors of the vehicles. There are various kinds of sensors suitable for the vehicles. Basically, they can be categorized into two. One is active and the other is passive. Active sensors means that they transmit electromagnetic waves actively and receive the reflected signals. Passive sensors means that they just receive signals in some bands of electromagnetic waves.

Since the active sensors are able to modulate the transmitted signals, they can generally calculate the distances between the transmitter and the reflected object according to time differences between the transmissions and the receptions of signals. Reversely, the passive sensors are unable to calculate the distances by measuring the time difference between the transmissions and the receptions.

One of the representative active sensors used in the smart vehicles is RaDAR (radio detection and ranging). In this present application, RaDAR is referred as a system that uses radio waves to determine the distance (ranging) and direction (azimuth and elevation angles) of objects relative to the system. And the passive sensors can be represented by a camera which generally captures the visual light band of human eyes. Please refer to the following comparison Table 1 of these two kinds of sensors.

TABLE 1
comparison of the commonly used sensing
devices for autonomous vehicles

| Constraints | RGB Camera | RaDAR |
|---|---|---|
| sensor type | passive | active |
| lux interference | sensitive | insensitive |
| sun-exposure interference | sensitive | insensitive |
| weather interference | more sensitive | less sensitive |
| sensing range | short (typically | long (typically |
| | 50 meters) | 150 meters) |
| field of view | wide (typically | narrow (typically |
| | 60 degrees) | 30 degrees) |
| resolutions | dense/high | sparse/low |

Table 1 provides a comparison of the characteristics of different sensing devices commonly utilized in the autonomous vehicles. Imaging sensors, exemplified by RGB (Red/Green/Blue) cameras, receive light information reflected from surrounding objects and the environment, often illuminated by external light sources. In contrast, RaDAR functions as an active transducer comprising transmitter and receiver units to capture information from the surrounding environment. The specific characteristics of the RaDAR sensing modalities are determined by the type of medium utilized by the transmitter, influencing its operational behaviors. RaDAR employs radio frequency waves to measure the time of flight between the transmitter and received within a defined field of view.

Based on the information provided in Table 1 and the preceding discussion, it is evident that imaging sensors are susceptible to light interference, which can compromise the quality of the acquired image. In contrast, RaDAR transducers remain unaffected by light interference due to their operation within different spectra ranges compared to the visible spectrum. Therefore, in environments with specific light intensities, object detection using imaging sensors may not be advantageous compared to RaDAR-based object detection, particularly concerning lux interference considerations. Furthermore, the comparison underscores the potential for interference from sun exposure, particularly relevant to the application of sensing devices within the domain of autonomous vehicles. Direct exposure of the camera lens to sunlight can result in signal clipping, causing attenuation of color information within the glare-exposed range and obscuring salient details in the acquired image. In contrast, RaDAR transducers remain unaffected by sun exposure, mitigating the impact of sunlight interference due to their operation within audio-based radio wave frequencies.

The outdoor environment introduces independent variables that may adversely affect the performance of each sensing device. Adverse weather conditions, such as rain, fog, or haze, present unavoidable constraints that must be considered in object detection. Both cameras and RaDAR rely on non-contact sensing techniques, necessitating a medium for the transmission of information. However, adverse weather conditions can impede visibility by introducing undesired materials, such as water droplets or pollutants, which attenuate the efficacy of information transmission from objects to the respective sensing devices.

Considering both internal and external constraints, it becomes evident that they influence the quality of data and impact the performance of object detection for each sensor. However, since adverse conditions may not affect all sensors simultaneously, there is an opportunity to mitigate these drawbacks through a comprehensive framework that integrates multiple sensing modalities and object detection methodologies.

The advancements in imaging sensors have propelled them beyond passive-based techniques in cameras to active-based techniques such as RADAR transducer. This transition to active sensors introduces three-dimensional information, offering depth information in addition to the luminance and chrominance information provided by camera sensors. Furthermore, various implementations have emerged in the form of multi-sensing technology, aiming to aggregate comprehensive information from diverse sensing devices through data fusion, thereby enhancing the accuracy of object detection systems. However, despite these advancements, certain drawbacks persist in the development and performance of different types of sensing devices, as well as in prior art object detection with multi-sensing devices:
a. The quality of data from each type of sensing device for autonomous vehicles is susceptible to influence from both external and internal constraints. Any adverse constraint specific to a corresponding sensing device has the potential to degrade data quality.
b. Many prior art approaches that developed fusion technology for multi-sensing devices primarily focus on internal constraints, such as objects' relative positions, distances, and classifier reliability.
c. Some prior art methods that developed fusion technology for multi-sensing devices fuse information at the input level and employ a single classifier for object detection. This approach may lead to a higher miss rate.

Therefore, there exists a need for a detection fusion system that harnesses multi-sensing modalities to conduct object detection using multiple object detection algorithms (classifiers) for each type of sensing device across overlapping fields of view. Data fusion is also employed on the final detection results, offering comprehensive information for subsequent procedures. Specifically, the objectives of the present application are as follows:
A. to enhance the detection rate of classifiers from each sensor;
B. to design decision fusion while considering the unique characteristics and behaviors of each sensor; and
C. to provide final detection results encompassing bounding box locations (in pixels and in depths), object classes, and detection confidences.

### SUMMARY OF THE INVENTION

According to an embodiment of the present application, a fusion detection method is provided. The fusion detection method, comprising: establishing a table corresponding to multiple blocks of a frame, where N is a natural number; determining a value of each cell of the table according to a historical first value of objection detections of corresponding blocks across from a 0-th first sensing data to a N-th first sensing data and a historical second value of objection detections of the corresponding blocks across from a 0-th second sensing data to a N-th second sensing data; and determining whether an object detection of the frame is presented or not based on the value of the cell corresponding to the block of the object detection, wherein the 0-th first sensing data to the N-th first sensing data are gathered from a first sensor, the 0-th second sensing data to the N-th second sensing data are gathered from a second sensor, the 0-th first sensing data to the N-th first sensing data and the 0-th second sensing data to the N-th second sensing data are related to a overlapped field of view of the first and the second sensors.

Preferably, in order to make the object detections more reliable, wherein said determining the value of each cell of the table further comprises probabilistic divergence processes of the historical first value and the historical second value.

Preferably, in order to correlate object detections between two different sensing data before the fusion detection, the fusion detection method further comprises: correlating a first object detection in the N-th first sensing data with a second object detection in the N-th second sensing data; and when the correlating the first object detection with the second object detection fails, performing said determining step of whether the non-correlated second object detection of the frame is presented or not.

Preferably, in order to correlate moving object between different sensing data, wherein when a first location of the first object detection is within a range of a second location of the second object detection, the correlating the first object detection with the second object detection successes.

Preferably, in order to spatially synchronize two different kinds of sensing data, wherein the 0-th first sensing data to the N-th first sensing data comprises range-based first data and pixel-based first data which is transformed from the range-based first data according to a transformation matrix, wherein the 0-th second sensing data to the N-th second sensing data comprises pixel-based second data and range-based second data which is transformed from the pixel-based second data according to the transformation matrix.

Preferably, in order to set up the transformation matrix, wherein the transformation matrix is prepared by a joint calibration step with regard to the first sensor and the second sensor.

Preferably, in order to combine active sensor and passive sensor to get more accurate fusion results, wherein the first sensor is an active sensor and the second sensor is a passive sensor.

Preferably, wherein the first sensor is one of following kinds of sensors: a millimeter wave RaDAR; and a LiDAR (light detection and ranging).

According to an embodiment of the present application, a processor for fusion detection is provided. The processor is configured to execute computer instructions stored in a non-volatile memory to fulfill following: establishing a table corresponding to multiple blocks of a frame, where N is a natural number; determining a value of each cell of the table according to a historical first value of objection detections of corresponding blocks across from a 0-th first sensing data to a N-th first sensing data and a historical second value of objection detections of the corresponding blocks across from a 0-th second sensing data to a N-th second sensing data; and determining whether an object detection of the frame is presented or not based on the value of the cell corresponding to the block of the object detection, wherein the 0-th first sensing data to the N-th first sensing data are gathered from a first sensor, the 0-th second sensing data to the N-th second sensing data are gathered from a second sensor, the 0-th first sensing data to the N-th first sensing data and the 0-th second sensing data to the N-th second sensing data are related to a overlapped field of view of the first and the second sensors.

Preferably, in order to make the object detections more reliable, wherein said determining the value of each cell of the table further comprises probabilistic divergence processes of the historical first value and the historical second value.

Preferably, in order to correlate object detections between two different sensing data before the fusion detection, the processor is further configured to fulfill following: correlating a first object detection in the N-th first sensing data with a second object detection in the N-th second sensing data; and when the correlating the first object detection with the second object detection fails, performing said determining step of whether the non-correlated first object detection of the frame is presented or not.

Preferably, in order to correlate moving object between different sensing data, wherein when a first location of the first object detection is within a range of a second location of the second object detection, the correlating the first object detection with the second object detection successes.

Preferably, in order to spatially synchronize two different kinds of sensing data, wherein the 0-th first sensing data to the N-th first sensing data comprises range-based first data and pixel-based first data which is transformed from the range-based first data according to a transformation matrix, wherein the 0-th second sensing data to the N-th second sensing data comprises pixel-based second data and range-based second data which is transformed from the pixel-based second data according to the transformation matrix.

Preferably, in order to set up the transformation matrix, wherein the transformation matrix is prepared by a joint calibration step with regard to the first sensor and the second sensor.

Preferably, in order to combine active sensor and passive sensor to get more accurate fusion results, wherein the first sensor is an active sensor and the second sensor is a passive sensor.

Preferably, wherein the first sensor is one of following kinds of sensors: a millimeter wave RaDAR; and a LiDAR (light detection and ranging).

According to an embodiment of the present application, a fusion detection system is provided. The fusion detection system comprising: the aforementioned processor; the first sensor; and the second sensor.

The final detection results based on the determining steps offering comprehensive information for subsequent procedures. According to the test results, the objectives of the present application are goaled as follows:
A. enhancing the detection rate of classifiers from each sensor;
B. making decision fusion while considering the unique characteristics and behaviors of each sensor, i.e., one active sensor and one passive sensor; and
C. providing final detection results encompassing bounding box locations (in pixels and in depths), object classes, and detection confidences.

### BRIEF DESCRIPTION OF THE DRAWINGS

The advantages and spirit related to the present invention can be further understood via the following detailed description and drawings.

FIG. 1 is a top view of an autonomous vehicle 110 illustrates two fields of views of two onboard sensors looking forward in accordance with an embodiment of the present application.

FIG. 2 is a block diagram depicts a vehicular onboard system 200 for fusion detection in accordance with an embodiment of the present application.

FIG. 3 is a schematic block diagram depicts the host or the embedded module 230 in accordance with an embodiment of the present application.

FIG. 4 is a flowchart diagram illustrates a fusion detection method 400 in accordance with an embodiment of the present application.

FIG. 5 shows effects of spatial synchronization of RaDAR and camera.

FIG. 6 shows three standalone detections and correlations in accordance with embodiments of the present application.

FIG. 7 shows a fusion decision based on KL divergence process in accordance with an embodiment of the present application.

FIG. 8 depicts an input (left-hand side) and an output (right-hand side) from the decision fusion in accordance with an embodiment of the present application on a clear-afternoon data.

FIG. 9 depicts an input (left-hand side) and an output (right-hand side) from the decision fusion in accordance with an embodiment of the present application on a clear-evening data.

FIG. 10 depicts five scenarios encompassing potential false positives or negatives from either the camera or RaDAR.

### DETAILED DESCRIPTION OF THE PREFERRED EMBODIMENT

Some embodiments of the present application are described in detail below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

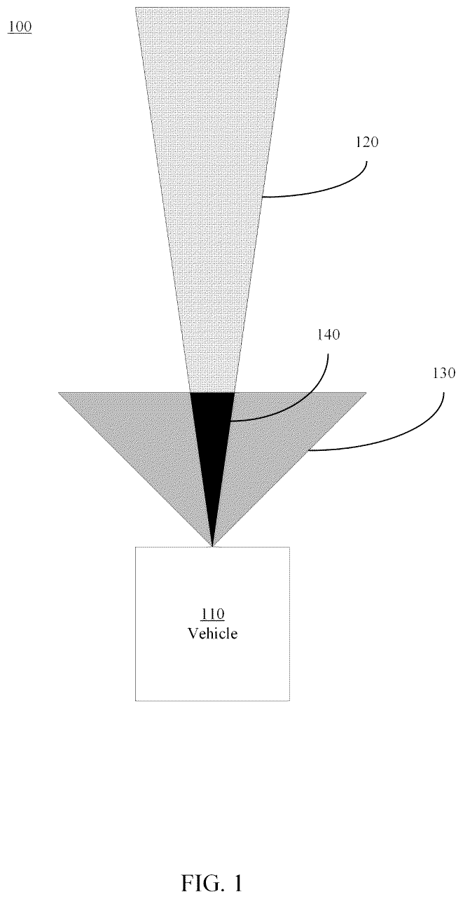

Please refer to FIG. 1, which is a top view of an autonomous vehicle 110 illustrates two fields of views of two onboard sensors looking forward in accordance with an embodiment of the present application. A narrow and long field of view 120 may be corresponding to a RaDAR sensor. A wide and short field of view 130 may be corresponding to a color camera sensor. An overlapped area 140 of these two views 120 and 130 is shown. One of the objectives of the present application is related to fuse two or more sensing data to detect objects in the overlapped area 140.

Although the embodiment as shown in FIG. 1 only illustrates two different kinds of sensors, people having ordinary skill in the art can understand that the present application may be applied to three or more kinds of sensors. In addition, the orientations of the two sensors as shown in FIG. 1 are aligned with a common axis. However, the present application does not limit to the aligned configuration. people having ordinary skill in the art can understand that the sensors may be installed in different places of the vehicle 110. The sensing data of one sensor may be linearly or non-linearly transformed to align with the sensing data of another sensor. Thus, corresponding to the overlapped area 140, the two or more sensing data from different sensors may be virtually aligned.

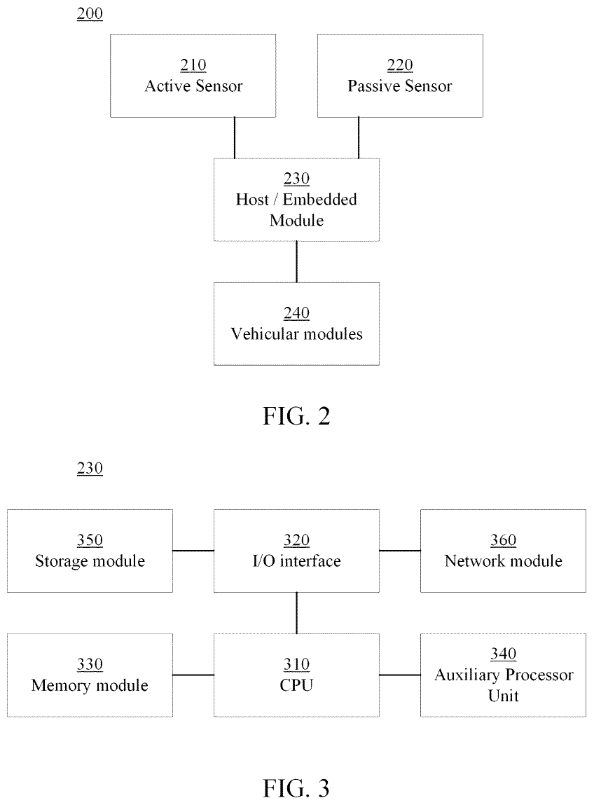

Please refer to FIG. 2, which is a block diagram depicts a vehicular onboard system 200 for fusion detection in accordance with an embodiment of the present application. The vehicular onboard system 200 may include an active sensor 210, a passive sensor 220, a host or an embedded module 230 for fusion detection, and one or more vehicular modules 240. In an alternative embodiment, these components may be physically interconnected by an unshown onboard data bus. The present application does not limit how these components are connected to each other.

In one embodiment, the active sensor 210 may be a RaDAR, or especially a millimeter wave RaDAR which may generate signal intensity values in a 3-axis coordinate space. The passive sensor 2220 may be a color camera which may generate red, green, blue intensity values in a 2-dimensional coordinate space. The sensing data generated by the active sensor 210 and the passive sensor 220 are fed into a host or an embedded module 230 for fusion detection. And from the host or the embedded module 230, the results of fusion detection are forwarded to the one or more vehicular modules 240, such as navigation module, autopilot module, and record module etc.

Although the embodiment as shown in FIG. 2 depicts two separate blocks 230 and 240, people having ordinary in the art can understand that these two blocks may be implemented in the same computer or machine. The present application does not limit how to implement the host or the embedded module 230 for fusion detection.

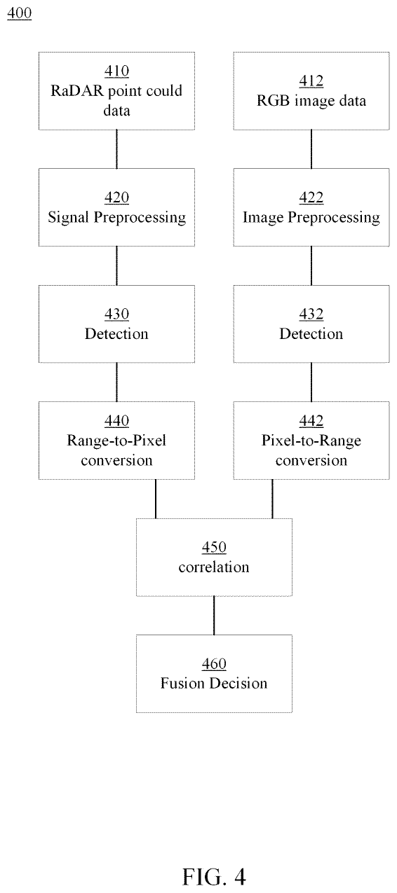

Please refer to FIG. 3, which is a schematic block diagram depicts the host or the embedded module 230 in accordance with an embodiment of the present application. The host or the embedded module 230 may include a CPU 310, an I/O interface 320, a memory module 330, an optional auxiliary processor unit 340, a storage module 350, and a network module 360. The CPU 310 may be used to execute computer instructions stored in the memory module 330 to implement the embodiments of the present application. The computer instructions may be operating system and specific applications which are stored in the storage module 350 such as EEPROM, disk, Flash memory, or any other kinds of non-volatile memory. The computer instructions may be also executed by the auxiliary processor unit 340 which may be a general graphic processing unit, a neural network processing unit, a scalar calculation unit, and any other forms of circuitry to accelerate the operations of the computer instructions for fulfilling the embodiments of the present application.

The sensing data provided by the active sensor 210 and the passive sensor 220 may be fed directly into the I/O interface 320. For examples, the I/O interface 320 may be compliant to an industrial standard, such as USB, PCI, PCI-Express, SCSI, iSCSI, SATA, FireWire, and any other kinds of interconnection standards. Alternatively, the sensing data provided by the active sensor 210 and the passive sensor 220 may be fed from the network module 360 which connects to an onboard data bus of the vehicle 110. Comparably, the results of fusion detection generated by the CPU 310 and/or the APU 340 may be transmitted via the network module 360 to the vehicular module 240, or through the I/O interface 320 directly.

Please refer to FIG. 4, which is a flowchart diagram illustrates a fusion detection method 400 in accordance with an embodiment of the present application. The fusion detection method 400 may be implemented by the vehicular onboard system 200 as shown in FIG. 2. Especially, the fusion detection method 400 may be implemented as computer instructions, stored in a non-volatile memory, being executed by the CPU 310 and/or the APU 340 as shown in FIG. 3.

The fusion detection method 400 is designed to enhance the detection efficacy of individual sensors, notably the camera 220 and the RaDAR 210, through a fusion detection approach. Illustrated in FIG. 4, the fusion detection method 400 may involves the following steps to achieve this objective. If there is no casual relation between any two steps indirectly or directly, the present application does not limit the execution order of these two steps. The fusion detection method 400 may begin with step 410 or step 412.

Step 410: the active sensor 210 gathers RaDAR point cloud data, representing echoes that delineate the volume of surrounding objects within the field of view 120.

Step 412: the passive sensor 220 gathers (RGB) image data. People having ordinary skill in the art can understand that image data may be represented by other forms of data. RGB image data used here is exemplified, merely.

Step 420: signal preprocessing the RaDAR point cloud data gathered in step 410 to generate RaDAR data regarding to the overlapped field of view, especially in the range dimension. As shown in FIG. 1, the field of view 120 corresponding to the active sensor 210 is longer than the field of view 130 corresponding to the passive sensor 220. Thus, the step 420 may filter the RaDAR point cloud data according to the overlapped field of view 140.

Step 422: image preprocessing the (RGB) image data gathered in step 412 may include cropping the image data regarding the overlapped field of view and/or resizing the image data to match the dimensions of the subsequent detection.

Step 430: detecting objects in the RaDAR point cloud data to generate the point clouds or bounding box sets within the overlapped field of view. The point clouds or bounding box sets are detection results in 3-dimensional real-world units. The unit data may include class information, coordinates, dimensions, and classifier confidence values.

Step 432: detecting objects in the image data. The image-based perception model may be implemented by one or more deep neural network models (such as convolutional neural network) or deep machine learning model. The image-based perception works on the image data to generate bounding box sets in 2-dimensional pixel units. Similar to the detection step 430, the detection information may also include class information, pixel coordinates, dimensions and classifier confidence values.

Step 440: spatial synchronization to convert the 3-dimensional range-based real-world units to pixel units using a transformation matrix.

Step 442: similarly, spatial synchronization to convert pixel-based information to range-based real-world units using the same transformation matrix.

The spatial synchronization process harmonizes the RaDAR point clouds and/or bounding boxes from their real-world-based coordinates to the corresponding pixel-based coordinates of the image data. Simultaneously, it aligns the camera's bounding boxes from pixel-based coordinates to real-world-based coordinates.

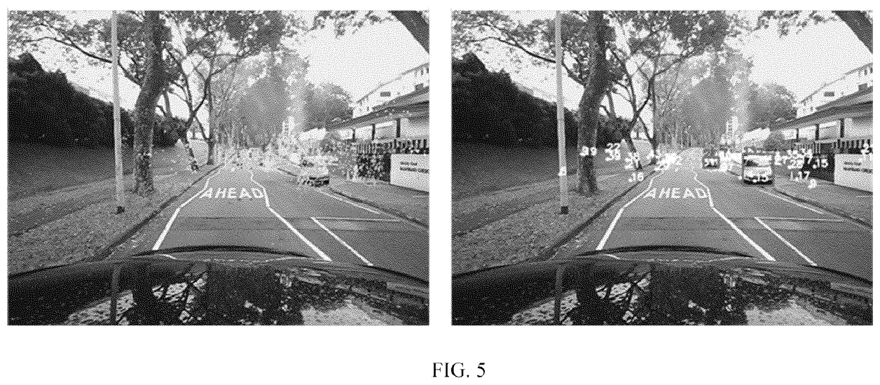

Please refer to FIG. 5, which shows effects of spatial synchronization of RaDAR and camera. Left-hand side part of FIG. 5 shows RaDAR point cloud data. And the right-hand side part of FIG. 5 visually demonstrates the spatial synchronization of RaDAR point clouds into pixel-based coordinates. The left-hand side depicts the raw data prior to any processing, while the right-hand side showcases the processed data. This synchronization facilitates seamless integration and analysis of data from both sensors, enhancing the system's overall effectiveness in detecting and identifying obstacles within the environment. By converting the RaDAR point clouds and camera bounding boxes into a shared coordinate system, the fusion algorithm can effectively combine the strengths of each sensor modality to improve detection accuracy and reduce false positives. This robust synchronization methodology is fundamental to the successful implementation of the late fusion technique, as depicted in FIG. 5.

Step 450: correlation. Before initiating the fusion decision step 460, a correlation step 450 may be performed between the RaDAR-based detection result and the camera-based detection result. This correlation hinges on the identification of overlapping detections between spatially synchronized RaDAR-based detection and corresponding camera-based detection.

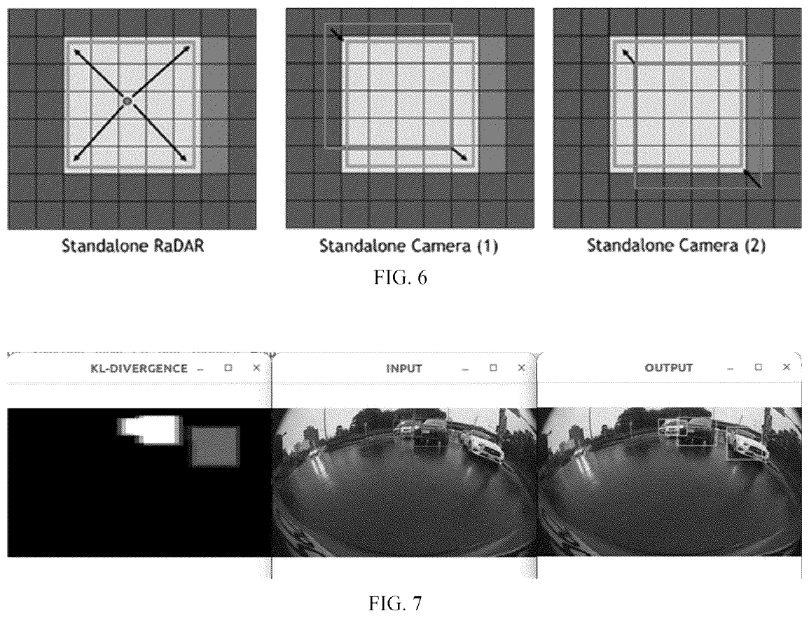

Please refer to FIG. 6, which shows three standalone detections and correlations in accordance with embodiments of the present application. Each RaDAR-based detection is meticulously mapped to a single camera-based detection box, establishing a direct correspondence between the two sensor outputs. Any points or bounding boxes from either datasets that lack a pairing or a mapping are identified as standalone detections. If any standalone detection is identified, a search for neighboring bounding boxes would be conducted.

In the event of standalone RaDAR or camera detections, the step 450 involves a meticulous search for neighboring bounding boxes wherein the associated blocks possess values exceeding a predefined threshold. In the case of standalone camera detections as show in the middle and in the right-hand side of FIG. 6, the search methodology is specifically conducted on the top-left and bottom-right corners, with the direction of the search contingent upon the value of the block under examination, as visually depicted in FIG. 6. This approach ensures comprehensive coverage and accurate localization of standalone detections, enhancing the overall robustness and reliability of the system.

Step 460: fusion decision according to a probabilistic divergence process based on the N preceding frames of datasets, where N is a natural number. This step measures the difference in entropy between two probability distributions: one derived from the detection results of the first sensor and the other derived from the detection results of the second sensor. In one embodiment, KL (Solomon Kullback-Richard Liebler) divergence process is used to determine or to integrate the two datasets from the sensors. KL divergence is a measure of relative entropy utilized to gauge the extent to which one probability distribution (in this embodiment, camera-based detection result) deviates from another (in this embodiment, RaDAR-based detection result), then expected probability distribution.

To establish probability maps for camera-based and RaDAR-based detections, an analysis of N preceding frames is conducted. To simplify probability estimation, the image's dimension is subdivided into a predetermined number of uniform-sized blocks. Each block is then assigned a binary value—0 indicating the absence of the corresponding detection and 1 indicating its presence—thus forming the confidence map for the t^{th} frame. The probability distribution is computed by averaging the confidence maps from the t^{th} to the t-N^{th} frames for both camera-based (C) and RaDAR-based (R) detections, as expressed by the following formula:

$${D}_{KL} = {\sum }_{i} C ( i ) log \frac{C ( i )}{R ( i )} \qquad ( 1 )$$

Here, i denotes the block index, C(i) represents the confidence of the bounding box across N frames, and R(i) signifies the confidence of the RaDAR point across N frames. It's important to clarify that ‘confidence’ in this context refers to the probability of detection presence within N frames, differing from the confidence value typically output by detection engines.

Please refer to FIG. 7, which shows a fusion decision based on KL divergence process in accordance with an embodiment of the present application. With reference to the KL divergence process, the fusion decision of the input makes out the output in the right-hand side of FIG. 7.

Person having ordinary skill in the art can understand that aforementioned KL divergence process is only an example of the present application. In short, each block may be determined according to historical records of identified objects. There are many kinds of computations to do this. The present application does not limit how the fusion decision is done, as long as the fusion decision is based on preceding frames of datasets from both sensors.

The transformation matrix utilized in steps 440 and 442 is obtained through a joint calibration step of the active sensor (RaDAR) 210 and the passive sensor (camera) 220. The joint calibration involves spatial calibration using a calibration pattern plate, constructing the camera's spatial coordinate system with the optical center as the origin. The X-axis and Z-axis align with the horizontal and vertical axes of the resized image, respectively, while the Y-axis extends outward from the lens through the optical center. The Y-axis represents depth or distance from the lens of the camera.

During calibration, the pattern plate is positioned multiple times to acquire image and point cloud data pairs from various perspectives. Both image and point cloud data undergo preprocessing, including image resizing and spatial synchronization with an initial transformation matrix estimate reflecting translational and rotational differences between the camera and the RaDAR.

The joint calibration embodies two processes: intrinsic parameter calibration and extrinsic parameter calibration. The intrinsic parameter calibration requires four input channels of camera horizontal and vertical field of view (θₓ, θ_{y}) and image width and height (i_{w}, iₕ) and the calculation of the intrinsic parameter calibration is as follows:

$${f}_{x} = \frac{{i}_{w}}{2 \times tan ( \frac{{θ}_{x}}{2} )} and {f}_{y} = \frac{{i}_{h}}{2 \times tan ( \frac{{θ}_{y}}{2} )} \qquad ( 2 )$$

and, the transformation matrix from the intrinsic parameter calibration is as follows:

$$[ \begin{matrix}{f}_{x} & 0 & {c}_{x} \\ 0 & {f}_{y} & {c}_{y} \\ 0 & 0 & 1\end{matrix} ] \qquad ( 3 )$$

The extrinsic parameter calibration requires six input channels of translational distance between the camera and RaDAR (tₓ, t_{y}, t_{z}) and rotational distance between the camera and RaDAR (rₓ, r_{y}, r_{z}) and the calculation of the extrinsic parameter calibration is as follows:

$$\overline{{r}_{x}} = [ \begin{matrix}1 & 0 & 0 \\ 0 & cos ( {r}_{x} ) & - sin ( {r}_{x} ) \\ 0 & sin ( {r}_{x} ) & - cos ( {r}_{x} )\end{matrix} ] \\ \overline{{r}_{y}} = [ \begin{matrix}cos ( {r}_{y} ) & 0 & sin ( {r}_{y} ) \\ 0 & 1 & 0 \\ - sin ( {r}_{y} ) & 0 & cos ( {r}_{y} )\end{matrix} ] \\ \overline{{r}_{z}} = [ \begin{matrix}cos ( {r}_{z} ) & - sin ( {r}_{z} ) & 0 \\ sin ( {r}_{z} ) & cos ( {r}_{z} ) & 0 \\ 0 & 0 & 1\end{matrix} ] \\ r = \overline{{r}_{x}} \times \overline{{r}_{y}} \times \overline{{r}_{z}} \qquad ( 4 )$$

and, the transformation matrix from the extrinsic parameter calibration is as follows:

$$[ \begin{matrix}{r}_{00} & {r}_{01} & {r}_{02} \\ {r}_{10} & {r}_{11} & {r}_{12} \\ {r}_{20} & {r}_{21} & {r}_{22}\end{matrix} ] [ \begin{matrix}{t}_{x} \\ {t}_{y} \\ {t}_{z}\end{matrix} ] \qquad ( 5 )$$

In contrast to intrinsic parameter calibration, extrinsic parameter calibration necessitates heuristic estimation of both translational and rotational distances between the camera and RaDAR as an initial approximation. Thus, each element within these distances may be adjusted iteratively to maximize overlap between point cloud and image data. This iterative refinement ensures optimal alignment for spatial synchronization, facilitating accurate fusion of sensor data.

$$( u , v ) = K \times ( ( r \times ( x , y , z ) ) + t ) \qquad ( 6 )$$

where K and t are constant parameters according to the joint calibration process.

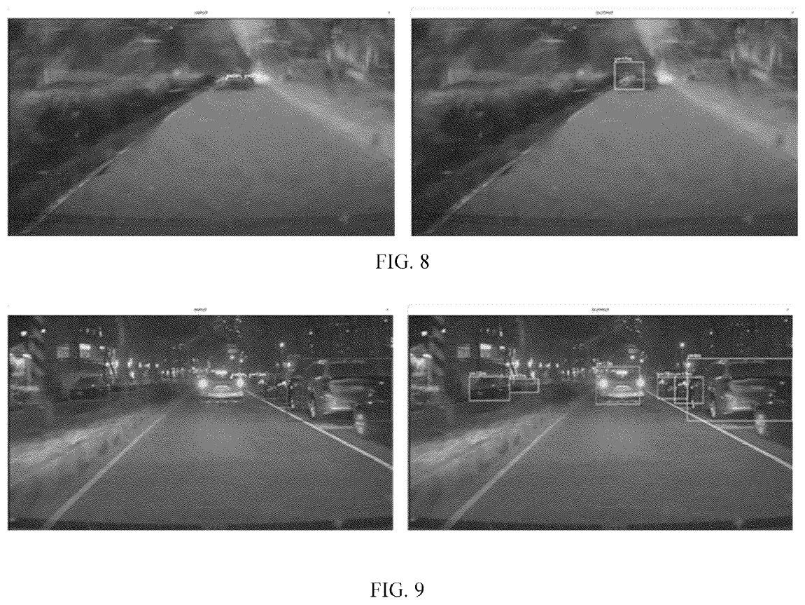

To assess the efficacy of the present application, test datasets were gathered under two distinct environmental conditions: clear-afternoon and clear-evening. Table 2 displays the total number of labeled frames, comprising 5000 frames for clear-afternoon and 2500 frames for clear-evening. Tables 3 and 4 present the performance metrics for camera-only and RaDAR-only detections. On average, camera-only detection achieves an accuracy rate of 90.0%, while RaDAR-only detection averages at 47.5% accuracy. Notably, camera-only detection outperforms RaDAR-only detection in both clear-afternoon and clear-evening scenarios. However, through late fusion, the accuracy rates of both camera-only and RaDAR-only detections experience significant improvements of +7.8% and +50.3%, respectively. These enhancements primarily stem from improvements in recall rates for both camera-only and RaDAR-only detections, while maintaining the precision rate of camera-only detection at near-optimal levels for both environmental scenarios. FIGS. 8 and 9 visually depict how the proposed method effectively fuses detection results from both the camera and RaDAR, illustrating the synergistic effect of late decision fusion in enhancing detection accuracy and robustness across varying environmental conditions.

TABLE 2
Test specifications

| Condition | Number of Frames |
|---|---|
| Clear Afternoon | 5000 |
| Clear Evening | 2500 |

TABLE 3
Performance evaluation results on Clear Afternoon

| Metric | Camera-only | RaDAR-only | Fusion |
|---|---|---|---|
| True-Positive | 4500 | 2750 | 4850 |
| False-Positive | 0 | 2090 | 10 |
| False Nagative | 500 | 2250 | 150 |
| Precision | 100.0% | 56.8% | 99.8% |
| Recall | 90.0% | 55.0% | 97.0% |
| Accuracy | 90.0% | 38.8% | 96.8% |

TABLE 4
Performance evaluation results on Clear Evening

| Metric | Camera-only | RaDAR-only | Fusion |
|---|---|---|---|
| True-Positive | 2250 | 1800 | 2470 |
| False-Positive | 0 | 710 | 0 |
| False Nagative | 250 | 700 | 30 |
| Precision | 100.0% | 71.7% | 100.0% |
| Recall | 90.0% | 72.0% | 98.8% |
| Accuracy | 90.0% | 56.1% | 98.8% |

In an embodiment, the bounding box sets of the RaDAR signal are gathered in the detection step 430, the bounding box sets may include class information, real-world coordinates, dimensions, and classifier confidences. Spatial synchronization subsequently converts real-word-based data into pixel units utilizing a transformation matrix derived from the joint calibration of the camera and RaDAR in step 440.

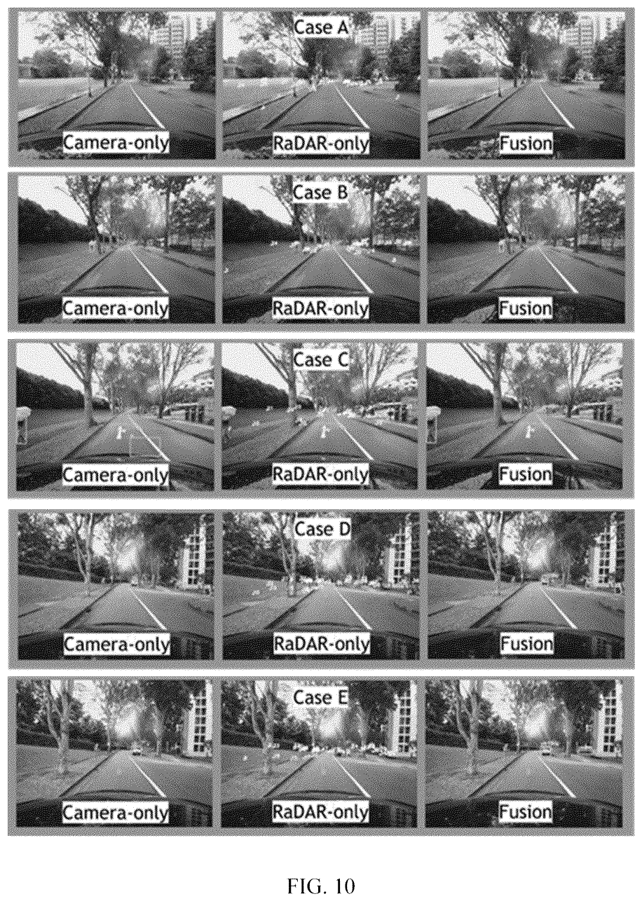

This methodology was assessed across five scenarios encompassing potential false positives or negatives from either the camera or RaDAR, as depicted in FIG. 10. Cases A and B in FIG. 10 illustrate a false negative and a false positive, respectively, stemming from camera-only detection. These inaccuracies were rectified through the fusion algorithm, given that the corresponding object was accurately detected via RADAR-only detection. Cases C and D in FIG. 10 exhibit a false negative and a false positive, respectively, originating from RADAR-only detection. Again, the fusion algorithm successfully addressed these inaccuracies, as the corresponding objects were correctly identified through camera-only detection. Case E of FIG. 10 demonstrates a false negative identified by both camera-only and RaDAR-only detections. The fusion algorithm effectively mitigated inaccuracies from both sensors, leveraging interframe confidence analysis via KL divergence.

According to an embodiment of the present application, a fusion detection method is provided. The fusion detection method, comprising: establishing a table corresponding to multiple blocks of a frame, where N is a natural number; determining a value of each cell of the table according to a historical first value of objection detections of corresponding blocks across from a 0-th first sensing data to a N-th first sensing data (the historical first value may be analogous to the confidences of the RaDAR point across N frames in the Formula (5)) and a historical second value of objection detections of the corresponding blocks across from a 0-th second sensing data to a N-th second sensing data (the historical second value may be analogous to the confidences of the bounding box across N frames in the Formula (5)); and determining whether an object detection of the frame is presented or not based on the value of the cell corresponding to the block of the object detection, wherein the 0-th first sensing data to the N-th first sensing data are gathered from a first sensor, the 0-th second sensing data to the N-th second sensing data are gathered from a second sensor, the 0-th first sensing data to the N-th first sensing data and the 0-th second sensing data to the N-th second sensing data are related to a overlapped field of view of the first and the second sensors.

Preferably, in order to make the object detections more reliable, wherein said determining the value of each cell of the table further comprises probabilistic divergence processes of the historical first value and the historical second value.

Preferably, in order to correlate object detections between two different sensing data before the fusion detection, the fusion detection method further comprises: correlating a first object detection in the N-th first sensing data with a second object detection in the N-th second sensing data; and when the correlating the first object detection with the second object detection fails, performing said determining step of whether the non-correlated second object detection of the frame is presented or not.

Preferably, in order to correlate moving object between different sensing data, wherein when a first location of the first object detection is within a range of a second location of the second object detection, the correlating the first object detection with the second object detection successes.

Preferably, in order to spatially synchronize two different kinds of sensing data, wherein the 0-th first sensing data to the N-th first sensing data comprises range-based first data and pixel-based first data which is transformed from the range-based first data according to a transformation matrix, wherein the 0-th second sensing data to the N-th second sensing data comprises pixel-based second data and range-based second data which is transformed from the pixel-based second data according to the transformation matrix.

Preferably, in order to set up the transformation matrix, wherein the transformation matrix is prepared by a joint calibration step with regard to the first sensor and the second sensor.

Preferably, in order to combine active sensor and passive sensor to get more accurate fusion results, wherein the first sensor is an active sensor and the second sensor is a passive sensor.

Preferably, wherein the first sensor is one of following kinds of sensors: a millimeter wave RaDAR; and a LiDAR (light detection and ranging).

According to an embodiment of the present application, a processor for fusion detection is provided. The processor is configured to execute computer instructions stored in a non-volatile memory to fulfill following: establishing a table corresponding to multiple blocks of a frame, where N is a natural number; determining a value of each cell of the table according to a historical first value of objection detections of corresponding blocks across from a 0-th first sensing data to a N-th first sensing data and a historical second value of objection detections of the corresponding blocks across from a 0-th second sensing data to a N-th second sensing data; and determining whether an object detection of the frame is presented or not based on the value of the cell corresponding to the block of the object detection, wherein the 0-th first sensing data to the N-th first sensing data are gathered from a first sensor, the 0-th second sensing data to the N-th second sensing data are gathered from a second sensor, the 0-th first sensing data to the N-th first sensing data and the 0-th second sensing data to the N-th second sensing data are related to a overlapped field of view of the first and the second sensors.

Preferably, in order to make the object detections more reliable, wherein said determining the value of each cell of the table further comprises probabilistic divergence processes of the historical first value and the historical second value.

Preferably, in order to correlate object detections between two different sensing data before the fusion detection, the processor is further configured to fulfill following: correlating a first object detection in the N-th first sensing data with a second object detection in the N-th second sensing data; and when the correlating the first object detection with the second object detection fails, performing said determining step of whether the non-correlated first object detection of the frame is presented or not.

Preferably, in order to correlate moving object between different sensing data, wherein when a first location of the first object detection is within a range of a second location of the second object detection, the correlating the first object detection with the second object detection successes.

Preferably, in order to spatially synchronize two different kinds of sensing data, wherein the 0-th first sensing data to the N-th first sensing data comprises range-based first data and pixel-based first data which is transformed from the range-based first data according to a transformation matrix, wherein the 0-th second sensing data to the N-th second sensing data comprises pixel-based second data and range-based second data which is transformed from the pixel-based second data according to the transformation matrix.

Preferably, in order to set up the transformation matrix, wherein the transformation matrix is prepared by a joint calibration step with regard to the first sensor and the second sensor.

Preferably, in order to combine active sensor and passive sensor to get more accurate fusion results, wherein the first sensor is an active sensor and the second sensor is a passive sensor.

Preferably, wherein the first sensor is one of following kinds of sensors: a millimeter wave RaDAR; and a LiDAR (light detection and ranging).

According to an embodiment of the present application, a fusion detection system is provided. The fusion detection system comprising: the aforementioned processor; the first sensor; and the second sensor.

The final detection results based on the determining steps offering comprehensive information for subsequent procedures. According to the test results, the objectives of the present application are goaled as follows:
A. enhancing the detection rate of classifiers from each sensor;
B. making decision fusion while considering the unique characteristics and behaviors of each sensor, i.e., one active sensor and one passive sensor; and
C. providing final detection results encompassing bounding box locations (in pixels and in depths), object classes, and detection confidences.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A fusion detection method, comprising:
establishing a table corresponding to multiple blocks of a frame, where N is a natural number;
determining a value of each cell of the table according to a historical first value of objection detections of corresponding blocks across from a 0-th first sensing data to a N-th first sensing data and a historical second value of objection detections of the corresponding blocks across from a 0-th second sensing data to a N-th second sensing data; and
determining whether an object detection of the frame is presented or not based on the value of the cell corresponding to the block of the object detection,
wherein the 0-th first sensing data to the N-th first sensing data are gathered from a first sensor, the 0-th second sensing data to the N-th second sensing data are gathered from a second sensor, the 0-th first sensing data to the N-th first sensing data and the 0-th second sensing data to the N-th second sensing data are related to a overlapped field of view of the first and the second sensors.

2. The fusion detection method as claimed in claim 1, wherein said determining the value of each cell of the table further comprises probabilistic divergence processes of the historical first value and the historical second value.

3. The fusion detection method as claimed in claim 1, further comprises:
correlating a first object detection in the N-th first sensing data with a second object detection in the N-th second sensing data; and
when the correlating the first object detection with the second object detection fails, performing said determining step of whether the non-correlated second object detection of the frame is presented or not.

4. The fusion detection method as claimed in claim 3, wherein when a first location of the first object detection is within a range of a second location of the second object detection, the correlating the first object detection with the second object detection successes.

5. The fusion detection method as claimed in claim 1,
wherein the 0-th first sensing data to the N-th first sensing data comprises range-based first data and pixel-based first data which is transformed from the range-based first data according to a transformation matrix,
wherein the 0-th second sensing data to the N-th second sensing data comprises pixel-based second data and range-based second data which is transformed from the pixel-based second data according to the transformation matrix.

6. The fusion detection method as claimed in claim 5, wherein the transformation matrix is prepared by a joint calibration step with regard to the first sensor and the second sensor.

7. The fusion detection method as claimed in claim 1, wherein the first sensor is an active sensor and the second sensor is a passive sensor.

8. The fusion detection method as claimed in claim 1, wherein the first sensor is one of following kinds of sensors: a millimeter wave RaDAR; and a LiDAR (light detection and ranging).

9. A processor for fusion detection, wherein the processor is configured to execute computer instructions stored in a non-volatile memory to fulfill following:
establishing a table corresponding to multiple blocks of a frame, where N is a natural number;
determining a value of each cell of the table according to a historical first value of objection detections of corresponding blocks across from a 0-th first sensing data to a N-th first sensing data and a historical second value of objection detections of the corresponding blocks across from a 0-th second sensing data to a N-th second sensing data; and
determining whether an object detection of the frame is presented or not based on the value of the cell corresponding to the block of the object detection,
wherein the 0-th first sensing data to the N-th first sensing data are gathered from a first sensor, the 0-th second sensing data to the N-th second sensing data are gathered from a second sensor, the 0-th first sensing data to the N-th first sensing data and the 0-th second sensing data to the N-th second sensing data are related to a overlapped field of view of the first and the second sensors.

10. The processor as claimed in claim 9, wherein said determining the value of each cell of the table further comprises probabilistic divergence processes of the historical first value and the historical second value.

11. The processor as claimed in claim 9, further configured to fulfill following:
correlating a first object detection in the N-th first sensing data with a second object detection in the N-th second sensing data; and
when the correlating the first object detection with the second object detection fails, performing said determining step of whether the non-correlated first object detection of the frame is presented or not.

12. The processor as claimed in claim 11, wherein when a first location of the first object detection is within a range of a second location of the second object detection, the correlating the first object detection with the second object detection successes.

13. The processor as claimed in claim 9,
wherein the 0-th first sensing data to the N-th first sensing data comprises range-based first data and pixel-based first data which is transformed from the range-based first data according to a transformation matrix,
wherein the 0-th second sensing data to the N-th second sensing data comprises pixel-based second data and range-based second data which is transformed from the pixel-based second data according to the transformation matrix.

14. The processor as claimed in claim 13, wherein the transformation matrix is prepared by a joint calibration step with regard to the first sensor and the second sensor.

15. The processor as claimed in claim 9, wherein the first sensor is an active sensor and the second sensor is a passive sensor.

16. The processor as claimed in claim 9, wherein the first sensor is one of following kinds of sensors: a millimeter wave RaDAR; and a LiDAR (light detection and ranging).

17. A fusion detection system, comprising: the processor; the first sensor; and the second sensor as claimed in claim 9.
